(19) United States
(12) Patent Application Publication
(10) Pub. No.: US 2026/0197335 A1
(43) Pub. Date: Jul. 9, 2026

(54) HUMAN AND BOT BEHAVIOR CLASSIFICATION FOR APPLICATION PROGRAMMING INTERFACE (API) SECURITY

(71) Applicant: Cequence Security, Inc., Sunnyvale, CA (US)

(72) Inventors: Vineeth Chigarangappa Rangadhamappa, Redwood City, CA (US); William Glazier, San Francisco, CA (US)

(21) Appl. No.: 19/444,640

(22) Filed: Jan. 9, 2026

Related U.S. Application Data
(60) Provisional application No. 63/743,348, filed on Jan. 9, 2025.

(51) Int. Cl. H04L 9/40

(52) U.S. Cl. CPC H04L 63/1425; H04L 63/104; H04L 63/1416

(57) ABSTRACT

Various embodiments include a system that comprises processing circuitry. The processing circuitry obtains and groups requests that share a characteristic to form a request group. For each of the requests in the request group, the processing circuitry determines header and body characteristics, compares the characteristics to expected header and body characteristics, and responsively generates an individual request score. The processing circuitry determines a short-term group characteristic for the request group and generates a short-term group score based on the short-term group characteristic. The processing circuitry determines a long-term group characteristic for the request group, compares the long-term group characteristic to an expected long-term group characteristic, and generates a long-term group score based on the comparison. The processing circuitry determines a trust score for the request group based on the individual request scores and the group scores and labels the request group as trusted when the trust score exceeds the threshold.

### CROSS-REFERENCE TO RELATED APPLICATIONS

This U.S. patent application claims the benefit of and priority to U.S. Provisional Patent Application 63/743,348 titled, “HUMAN AND BOT BEHAVIOR CLASSIFICATION FOR APPLICATION PROGRAMMING INTERFACE (API) SECURITY” which was filed on Jan. 9, 2025, and which is hereby incorporated by reference into this U.S. patent application in its entirety.

### TECHNICAL FIELD

Various embodiments of the present technology relate to web security, and more specifically, to classifying human and bot behavior for Application Programming Interface (API) security.

### BACKGROUND

The security of a web service is of upmost importance to both the operators of the website and its users. As Internet communications expand for business transactions and other services, more threats to website security arise. Website owners, insurers, hosting services, and others involved in the provision of a web service typically strive to create a robust security infrastructure for a website to prevent nefarious individuals from compromising the site. However, despite these security precautions, a website could still be subject to intrusions by computer hackers, malware, viruses, and other malicious attacks. Websites may be vulnerable to security breaches for a variety of reasons, including security loopholes, direct attacks by malicious individuals or software applications, dependencies on compromised third-party providers, and other security threats. Security systems are employed by websites to counteract the wide range of threats.

Many web applications utilize Application Programming Interfaces (APIs) based applications for functions like sales productivity, collaboration, marketing automation, and project tracking. API usage has increased as organizations have expanded their use of microservices and created new cloud-native applications. The consumer-facing applications that the organizations create are often API based. This API ecosystem is fueled by increases in public cloud environments, Kubernetes environments, serverless environments, and use of third-party Software As A Service (SaaS) systems. Developers may roll out new API driven services in any environment. Critical information like personal information, financial information, health information, and the like is stored behind the applications that host these APIs.

Web applications are often the target of sophisticated bot attacks. For example, malicious actors often target APIs as entry points for to perform unwanted actions (e.g., obtaining sensitive data like credit card numbers, banking information, personal identifying information, and the like). The enterprises that host the web applications employ security services to counter bot activity. The security services traditionally use a set of handcrafted rules to block bot activity. However, due to the resources available to the organizers of bot attacks as well as the ever-changing landscape in an organization's API infrastructure, the rules-based approach to block bot attacks is often inadequate. Unfortunately, security systems do not effectively and efficiently inhibit bot attacks given the dynamic and growing set of tools available to attackers.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for classifying human and bot behavior for Application Programming Interface (API) security. Some embodiments comprise a method. The method comprises obtaining requests and grouping the requests based on a characteristic shared by the requests to form a request group. The method further comprises determining, for each of the requests in the request group, a header characteristic and a body characteristic, comparing the header characteristic to an expected header characteristic, comparing the body characteristic to an expected body characteristic, and generating an individual request score based on the comparisons. The method further comprises determining a short-term group characteristic for the request group and generating a short-term group score based on the short-term group characteristic. The method further comprises determining a long-term group characteristic for the request group, comparing the long-term group characteristic to an expected long-term group characteristic, and generating a long-term group score based on the comparison. The method further comprises determining a trust score for the request group based on the individual request scores for each of the requests, the short-term group score, and the long-term group score, comparing the trust score to a threshold, and labeling the request group as trusted when the trust score exceeds the threshold.

Some embodiments comprise a system. The system comprises processing circuitry. The processing circuitry obtains requests and groups the requests based on a characteristic shared by the requests to form a request group. For each of the requests in the request group, the processing circuitry determines a header characteristic and a body characteristic, compares the header characteristic to an expected header characteristic, compares the body characteristic to an expected body characteristic, and generates an individual request score based on the comparisons. The processing circuitry determines a short-term group characteristic for the request group and generates a short-term group score based on the short-term group characteristic. The processing circuitry determines a long-term group characteristic for the request group, compares the long-term group characteristic to an expected long-term group characteristic, and generates a long-term group score based on the comparison. The processing circuitry determines a trust score for the request group based on the individual request scores for each of the requests, the short-term group score, and the long-term group score, compare the trust score to a threshold, and label the request group as trusted when the trust score exceeds the threshold.

Some embodiments comprise one or more non-transitory computer readable storage media that store program instructions. When executed by a computing system, the program instructions direct the computing system to perform operations. The operations comprise obtaining requests and grouping the requests based on a characteristic shared by the requests to form a request group. The operations further comprise determining, for each of the requests in the request group, a header characteristic and a body characteristic, comparing the header characteristic to an expected header characteristic, comparing the body characteristic to an expected body characteristic, and generating an individual request score based on the comparisons. The operations further comprise determining a short-term group characteristic for the request group and generating a short-term group score based on the short-term group characteristic. The operations further comprise determining a long-term group characteristic for the request group, comparing the long-term group characteristic to an expected long-term group characteristic, and generating a long-term group score based on the comparison. The operations further comprise determining a trust score for the request group based on the individual request scores for each of the requests, the short-term group score, and the long-term group score, comparing the trust score to a threshold, and labeling the request group as trusted when the trust score exceeds the threshold.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a system that characterizes human and bot behavior to block bot attacks.

FIG. 2 illustrates an example operation of the system to characterize human and bot behavior to block bot attacks.

FIG. 3 illustrates an example of another system that characterizes human and bot behavior to block bot attacks.

FIG. 4 illustrates an example operation of the other system to characterize human and bot behavior to block bot attacks.

FIG. 5 illustrates an example of charts that depict human and bot behavior.

FIG. 6 illustrates an example of a computing system for characterizing human and bot behavior to block bot attacks.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### Technical Description

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Organizations today face an escalating threat from sophisticated bot attacks that compromise the security and integrity of their online services. The easy availability of computational resources from cloud infrastructure providers and a large cache of open-source tools to test or attack an organization's web assets (like API servers) enables a person with a minimal knowledge of cyber security to mount a bot attack campaign on that organization. Bot attacks are generally launched for purposes of illicit monetary gain like credit card fraud, gift card fraud, organization customer account take overs, or undue accumulation of rare merchandise like limited edition sneakers, game consoles, and the like. Conventional identification of these bot behaviors relies on hand crafted rules or signatures in web/API application protection frameworks. These signatures are ever changing to keep up with the evolving bot behaviors. While it is admirable to keep up with identifying these bad bot behavior signatures, it can be very tedious. As such, the traditional methods of bot mitigation, which rely heavily on manual analysis and the creation of IP-based policies or static signature-based policies, fall short in addressing these challenges.

To address these deficiencies of conventional bot detection systems, various embodiments of the present technology relate to a security system that characterizes human and bot behavior to block bot attacks. It is advantageous to detect all possible good browser behaviors accurately and block/mitigate any pattern that lies outside of the good collection. This necessitates a way to reliably identify good behavior automatically. The security system provides a mechanism to quantify the extent of good behavior by calculating a trust score. The security system detects, measures, and mitigates malicious bot behaviors automatically by calculating the trust score and optionally using standard handcrafted rules to detect aggregate behavior of a browser.

In some examples, an organization's customer interacts with the organization's web/API assets via a web browser. The transaction follows a typical client-server model where the client makes a Hypertext Transport Protocol (HTTP) request to an organization web Uniform Resource Locator (URL) or an API endpoint. The security system groups the HTTP requests based on their source HTTP client browser characteristics into different groups called fingerprints (also referred to as request groups) and/or another type of pivot. The security system continuously processes the HTTP traffic in a streaming fashion and the content of the HTTP requests, along with insights/characterization data, is stored/indexed in a datastore. The primary insight is the confidence score, which represents a cumulative sum of the weights of handcrafted rules that are associated with the HTTP request.

The security system retrieves the records from the datastore periodically (e.g., every 15 minutes) via an aggregation query that groups records by fingerprint and URL. This query gathers confidence score distribution data for all the fingerprints active in that time-window on a per URL basis. From this data, the security system computes the fingerprint's 25th percentile or median (or any other percentile metric) confidence score. Among these fingerprints, the security system assembles a list of curated bad fingerprints for bot mitigation. The fingerprints that fall in this list may meet the following two criteria: the fingerprint's confidence score is greater than a configurable threshold and the fingerprint is not part of a dynamic good fingerprint list that is continuously learned and updated on a daily basis by the security system. The security system provides the curated bad-fingerprint-list to a security proxy associated with the organization to mitigate and block all the HTTP requests originating from these fingerprints. Although, the abstract framework in above example is explained using fingerprint as a pivot, the pivot may comprise an IP address, user agent string or any such header value, any component (or combinations of multiple components) of an HTTP request, any combination of a HTTP request and URL, and the like. Additionally, the security system provides a mechanism to learn and maintain a dynamic good fingerprint list automatically based on the trust score.

The security system determines the likelihood for an HTTP request to have originated from a legitimate source based on the HTTP request's fingerprint behavior over time. The likelihood is measured by a fingerprint's trust score based on the pivot's behavior at a customer over a period of time. The trust score determines the likelihood that a particular HTTP request originates from a web browser or a mobile application. A fingerprint represents an HTTP web browser client. The security system collects all the requests received by a web application over a period of time (e.g., three days) and categorizes them into a single request bucket, single day batch bucket, and a multi-day batch bucket based on the analysis time frame. Requests assigned to the single request bucket are processed individually, compared to an expected request, and scored based on their similarity to the expected request. Requests assigned to the single day batch bucket are processed as a group and scored based on one or more metrics. Requests assigned to the multi-day batch bucket batch bucket are processed as a group and scored based on the pattern of the request volume over time. The security system combines the scores from each of the buckets using a weighted sum to generate the trust score. If the trust score exceeds a threshold, the security system adds that fingerprint to the dynamic good fingerprint list. The security system may provide the curated good-fingerprint-list to the security proxy associated with the organization to allow all the HTTP requests originating from these fingerprints. Now referring to the Figures.

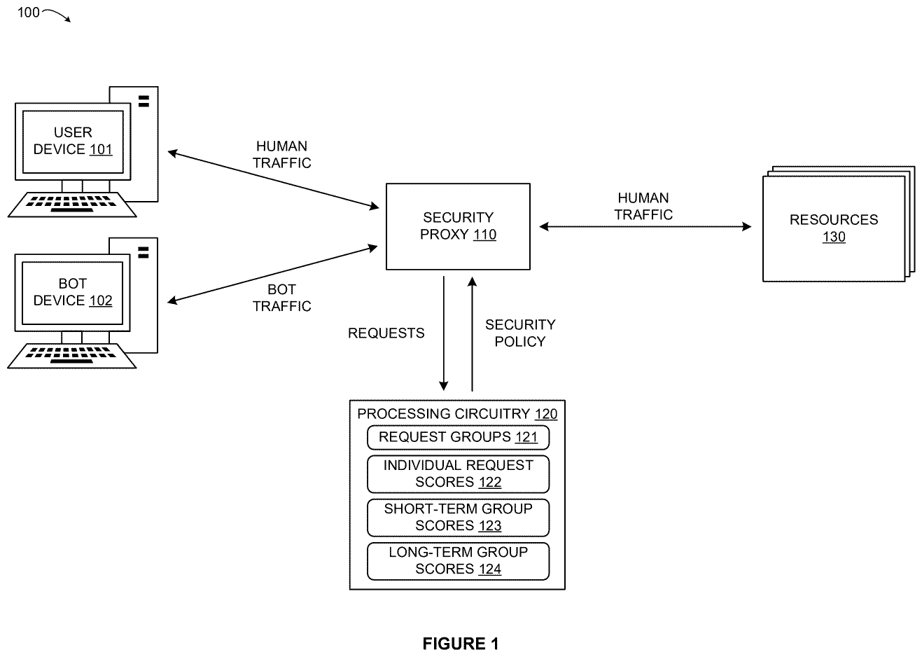

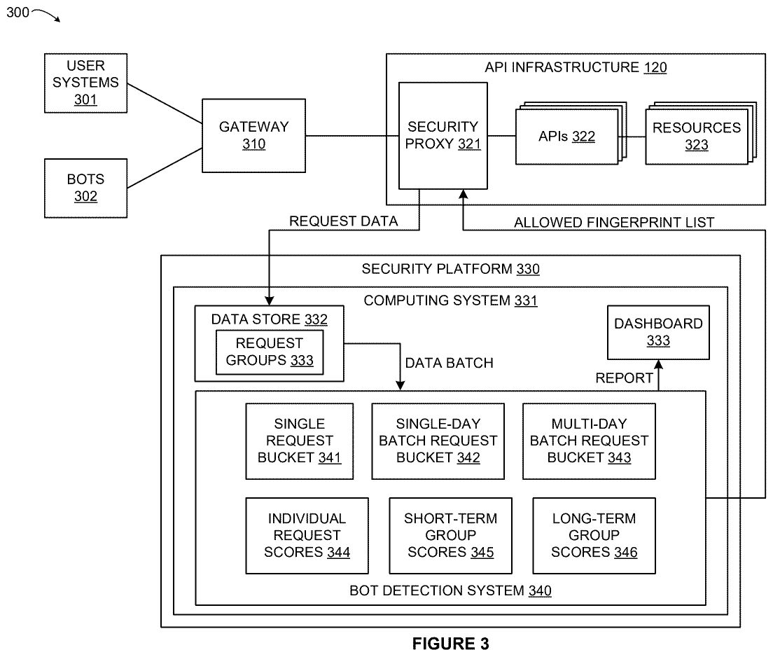

FIG. 1 illustrates an example of system 100 to characterize human and bot behavior to block bot attacks. System 100 comprises an example of system 300 illustrated in FIG. 3, however system 300 may differ. System 100 provides services like online networking, content distribution, web application services, web application security, machine learning, data logging, data aggregation, and the like. System 100 comprises user device 101, bot device 102, security proxy 110, processing circuitry 120, and resources 130. Processing circuitry 120 comprises request groups 121, individual request scores 122, short-term group scores 123, and long-term group scores 124. In other examples, system 100 may comprise additional or different elements than those illustrated in FIG. 1. Likewise, the illustrated components of system 100 may include fewer or additional components, assets, or connections than shown. User device 101, bot device 102, security proxy 110, processing circuitry 120, and resources 130 may be representative of a single computing apparatus or multiple computing apparatuses.

Various examples of system operation and configuration are described herein. In some examples, user device 101 and bot device 102 transfer requests to access resources 130 via security proxy 110. For example, the requests may comprise HTTP requests, API calls, and the like. While resources 130 are depicted as web resources (e.g., URLs, API endpoints, etc.), resources 130 may comprise any type of communication endpoint. Security proxy 110 copies the human and bot requests to processing circuitry 120. Security proxy 110 also applies security policies to block traffic received from bot device 102 from reaching resources 130. For example, the traffic received from bot device 102 may attempt to access unauthorized resources, drive resources 130 to expose sensitive user information, engage in criminal activity, and/or perform some other unwanted operation.

Processing circuitry 120 receives the human and bot traffic from security proxy 110. Processing circuitry 120 groups the requests based on shared characteristics to form request groups 121. For example, processing circuitry 120 may form one of request groups 121 using a set of HTTP requests that share client browser characteristics. For each of request groups 121, processing circuitry 120 determines header characteristics and body characteristics for each request. Exemplary header/body characteristics include header position, header value, header value component count, request version, and the like. Processing circuitry 120 compares the header characteristics for each request to expected header characteristics and compares the body characteristics for each request to expected body characteristics. Processing circuitry 120 generates individual request scores 122 for the each of request groups 121 based on the comparisons. Individual request scores 122 characterize the legitimacy of the individual requests assigned to request groups 121.

Processing circuitry 120 determines short-term group characteristics for each of request groups 121. The short-term group characteristics indicate the aggregate short-term behavior, characteristics, attributes, and the like of the requests assigned to a given one of request groups 121. Exemplary short-term group characteristics include the proportion of client transaction errors, proportion of failed transactions, proportion of the requests originating from untrusted Internet Service Providers (ISPs), average requests per client Internet Protocol (IP) address, proportion of the requests below a confidence threshold, and the like. Processing circuitry 120 generates short term group scores 123 for each of request groups 121 based on their respective short-term group characteristics. Short-term group scores 123 characterizes the legitimacy of the short-term activity of one request groups 121.

Processing circuitry 120 determines long-term group characteristics for each of request groups 121. The long-term group characteristics indicate the aggregate long-term behavior, characteristics, attributes, and the like of the requests assigned to a given one of request groups 121. Exemplary long-term group characteristics include request volume and request volume periodicity. Processing circuitry 120 compares the long-term group characteristics to expected long-term group characteristics and generates long-term group scores 124 for each of request groups 121. Long-term group scores 124 characterize the legitimacy of the long-term activity of request groups 121.

Processing circuitry 120 determines trust scores for request groups 121 based on their respective ones of individual request scores 122, short-term group scores 123, and long-term group scores 124. Processing circuitry 120 compares the trust scores to a threshold and labels ones of request groups 121 that exceed the threshold as trusted. Processing circuitry 120 generates security polices to block requests that do not fall into a trusted one of request groups 121. Processing circuitry 120 provides the security policies to security proxy 110. Security proxy 110 applies the security policies to block additional requests received from bot device 102.

Advantageously, processing circuitry 120 effectively and efficiently characterizes human and bot behavior to block bot attacks. Moreover, processing circuitry 120 inhibits attackers from using new tools and bot attack techniques by automatically blocking traffic that does not conform to trusted request fingerprints.

While user device 101 and bot device 102 are illustrated as comprising a personal computer, user device 101 and bot device 102 may comprise another device with data communication circuitry like a smartphone, a server computer, a sensor, a drone, a vehicle, and the like. User device 101, bot device 102, security proxy 110, processing circuitry 120, and resources 130 communicate over communication systems like routers, gateways, telecommunication switches, servers, processing systems, or other communication equipment and systems for providing communication and data services. The communication systems could comprise wireless communication nodes, telephony switches, Internet routers, network gateways, computer systems, communication links, or some other type of communication equipment, including combinations thereof. The communication systems may also comprise optical networks, packet networks, local area networks (LAN), metropolitan area networks (MAN), wide area networks (WAN), or other network topologies, equipment, or systems, including combinations thereof.

User device 101, bot device 102, security proxy 110, processing circuitry 120, and resources 130 may communicate over wired or wireless communication links. The communication links that connect the elements of system 100 use metallic links, glass fibers, radio channels, or some other communication media. The communication links may use Internet Protocol (IP), Time Division Multiplex (TDM), Data Over Cable System Interface Specification (DOCSIS), IP, General Packet Radio Service Transfer Protocol (GTP), Institute of Electrical and Electron Engineers (IEEE) 802.11 (Wifi), IEEE 802.3 (Ethernet), optical networking, wireless protocols, communication signaling, virtual switching, inter-processor communication, bus interfaces, or some other communication format, including combinations thereof.

User device 101, bot device 102, security proxy 110, processing circuitry 120, and resources 140 comprise microprocessors, software, memory, transceivers, bus circuitry, and the like. The microprocessors comprise Central Processing Units (CPU), Graphical Processing Units (GPU), Application-Specific Integrated Circuits (ASIC), Field Programmable Gate Array (FPGA), and/or types of processing circuitry. The memories comprise Random Access Memory (RAM), Solid State Drives (SSDs), Hard Disk Drives (HDDs), Non-Volatile Memory Express (NVMe) SSDs, and/or the like. The memories store software like operating systems, security modules, machine learning models, user applications, web applications, and browser applications. The microprocessors retrieve the software from the memories and execute the software to drive the operation of system 100 as described herein.

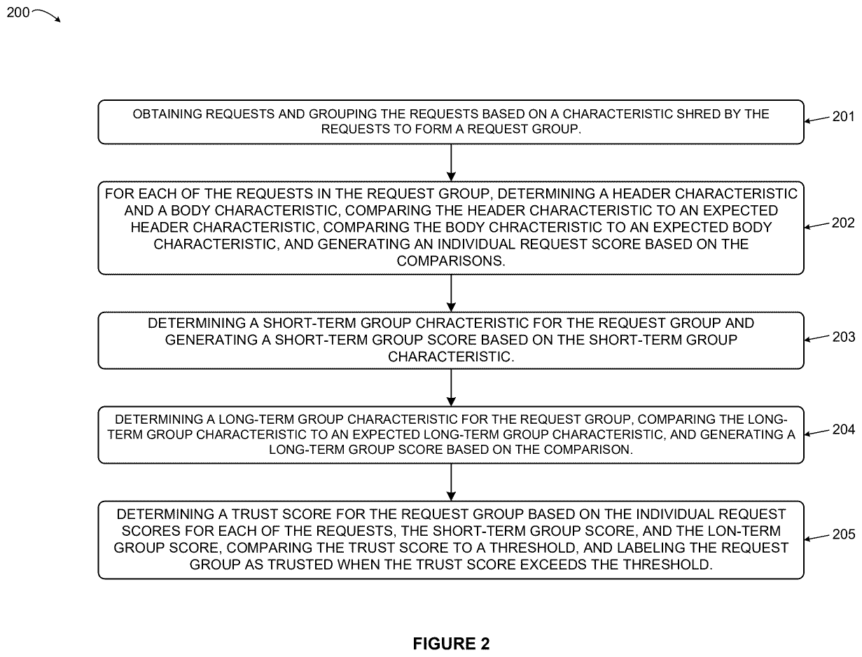

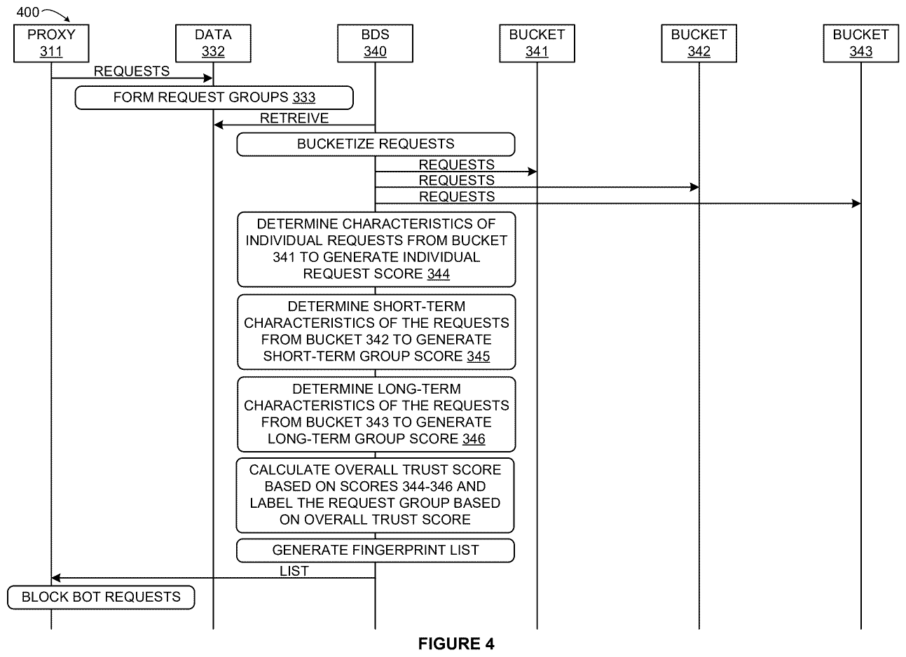

In some examples, system 100 implements process 200 illustrated in FIG. 2 and/or process 400 illustrated in FIG. 4. It should be appreciated that the structure and operation of system 100 may differ in other examples.

FIG. 2 illustrates an example of process 200. Process 200 comprises an exemplary operation of system 100 to characterize human and bot behavior to block bot attacks. Processing 200 comprises an example of process 400 illustrated in FIG. 4, however process 400 may differ. The operations of process 200 may vary in other examples. The operations of process 200 comprise obtaining requests and grouping the requests based on a characteristic shared by the requests to form a request group (step 201). The operations further comprise, for each of the requests in the request group, determining a header characteristic and a body characteristic, comparing the header characteristic to an expected header characteristic, comparing the body characteristic to an expected body characteristic, and generating an individual request score based on the comparisons (step 202). The operations further comprise determining a short-term group characteristic for the request group and generating a short-term group score based on the short-term group characteristic (step 203). The operations further comprise determining a long-term group characteristic for the request group, comparing the long-term group characteristic to an expected long-term group characteristic, and generating a long-term group score based on the comparison (step 204). The operations further comprise determining a trust score for the request group based on the individual request scores for each of the requests, the short-term group score, and the long-term group score, comparing the trust score to a threshold, and labeling the request group as trusted when the trust score exceeds the threshold (step 205).

FIG. 3 illustrates system 300 to characterize human and bot behavior to block bot attacks. System 300 comprises an example of system 100 illustrated in FIG. 1, however system 100 may differ. System 300 comprises user systems 301, bots 302, gateway 310, API infrastructure 320, and security platform 330. Infrastructure 320 comprises security proxy 321, APIs 322, and resource 323. Security platform 330 comprises computing system 331, data store 332, and dashboard 334. Data store comprises request groups 333. Security platform 330 hosts bot detection system 340. Bot detection system 340 comprises single request bucket 341, sing-day batch request bucket 342, multi-day batch request bucket 343, individual request scores 344, short-term group scores 345, and long-term group scores 346. In other examples, system 300 may comprise additional or different elements than those illustrated in FIG. 3. Likewise, the illustrated components of system 300 may include fewer or additional components, assets, or connections than shown. User systems 301, bots 302, gateway 310, API infrastructure 320, and security platform 330 may be representative of a single computing apparatus or multiple computing apparatuses.

In some examples, user systems 301 and bots 302 transfer requests towards API infrastructure 320 over gateway 310 to access resources 323. The requests may comprise Hypertext Transport Protocol (HTTP) requests, API calls, and the like. The requests are addressed to ones of APIs 322. Gateway 310 routes the requests to API infrastructure 320. Security proxy 321 applies security policies to block malicious or otherwise unwanted requests from reaching APIs 322. APIs 322 receive the requests, access resources 323, and return responses to user system 301 and/or bots 302 over gateway 310. The responses may comprise HTTP messages, API responses, and the like. Security proxy 321 copies the requests and potentially other security relevant information to data store 332. Security proxy 321 may generate and transfer data characterizing the requests to data store 332. The data may characterize request volume, request header characteristics, request failures, request origins, and the like.

Data store 332 receives the copied requests from security proxy 321. Data store 332 groups the requests based on the request characteristics to create request groups 333. Request groups 333 each comprise a set of requests with shared request characteristics. Data store 332 may group the requests based on client browser characteristics, Internet Protocol (IP) address, header value (e.g., user agent string), request body components, Uniform Resource Locator (URL), and the like. Request groups 333 may be referred to as fingerprints. Bot detection system 340 determines the likelihood that requests in a given request group originate from a legitimate source. The likelihood is measured by a request group's trust score which characterizes the request group's behavior over a period of time. The trust score characterizes the possibility that a request from that request group is legitimate and evaluates the request group's activity over time in order to predict if the type of user is a human or non-human (aka bot-like) with a degree of confidence. For example, the trust score may determine the likelihood that a particular request originates from a web browser or a mobile application. Bot detection system 340 calculates the trust score for a request group based on single request characteristics, short term (e.g., single day) request batch characteristics, and long term (e.g., multi-day) request batch characteristics.

Bot detection system 340 collects all the requests received over a time period (e.g., three days) for a given request group and categorizes them into buckets 341-343. Bot detection system 340 loads all of the requests for the request group to bucket 341. Bucket 341 represents a single request view. Assuming the request group to be a fingerprint, the features of a single request from the fingerprint are considered in the trust score computation. These features are chosen for their commonality across all the requests (e.g., HTTP requests) originating from the fingerprint. For example, the features may comprise header positions in the request payload, request header values, header value components count (e.g., number of accepted value counts) request version, and the like. Bot detection system 340 generates individual request scores 344 based on the features of the requests assigned to single request bucket 341. If any of the above features are absent in the request, bucket 341 assigns that particular feature a value of −1. For example, the following table may be representative:

| | Header | Header Value | Request Body | HTTP Request |
|---|---|---|---|---|
| Fingerprint | Position | Count | Value Position | Version |
| Fingerprint 1 | 3 | 7 | −1 | 1 |
| Fingerprint 2 | 1 | 2 | 0 | 1 |
| Fingerprint 3 | 4 | 5 | 1 | 1 |

The fingerprints in the above table are sorted into browser engine clusters based on their feature vector being similar to their ground truths. A ground truth vector is the expected vector for that fingerprint. The ground truth vectors for well-known browsers are obtained by making a request from that well-known browser (e.g., trusted) to security platform 330 in an automated fashion. The extent of similarity is computed based on the hamming distance between two vectors. This hamming distance is converted to a normalized score between 0 and 1, where 0 indicates the two vectors are completely different and 1 indicates the two vectors to be identical. Prior to computing the hamming distance, the feature vector containing numerical digits are mapped to a vector containing a sequence of characters through a suitable transformation. Among the above set of fingerprints, few representative features are considered to be ground truths based on prior information. These anchor vectors represent the ground truth for their browser engine group. The similarity scores are then computed for every other fingerprint's feature vector to these anchor vectors. The final bucket score (i.e., individual request scores 344) for a fingerprint is then computed by multiplying the maximum similarity score with 20. Thus, a score of 20 indicates the fingerprint's vector is identical to one of the known browser engines' vectors and a score of 0 indicates the fingerprint's vector is vastly different from the known browser engines' vector.

Bot detection system 340 assigns requests captured over a 24-hour time period to bucket 342. Bucket 342 represents an aggregate short-term view of the request group. Assuming the one of request groups 333 to be a fingerprint, the following steps describe the methodology used to compute bucket 342's score (i.e., short-term group scores 345). Bot detection system 340 collects, for a given fingerprint, one day (or some other time period) aggregated metrics from datastore 332. Bot detection system 340 computes the score for bucket 342 using an empirical formula. The behavioral characteristics targeted in bucket 342 are slightly different from the other two buckets. Notably, these characteristics measure and explain behavior that is deemed bad which helps to avoid false positives. To start with, every fingerprint with less than 5 requests per day receives a bucket score of only 1. The rest of the fingerprints are analyzed and rewarded with the highest possible bucket score of 50 if their one-day aggregated data doesn't exhibit a defined set of bad or otherwise unwanted behaviors. These behaviors include the proportion of a request group's transaction that are client errors, the proportion of a request group's transactions that fail, a threshold proportion of the request group originates from an untrusted Internet Service Provider (ISP), the average requests per client IP address approaches 1, the proportion of the requests with a low confidence score, and the like. The following table lists the bad behavior and exemplary reward scores for each of them:

| | Request Group |
|---|---|
| | Reward Score When |
| Behavior Tested For | Behavior Is Absent |
| B1: Threshold level of transactions are client | 14 |
| errors (i.e., 4xx status codes) | |
| B2: B1 and threshold level of failed | 30 |
| transactions | |
| B3: B2 and threshold level of request | 40 |
| originate from ISPs deemed untrustworthy | |
| B4: B3 and average requests per client IP | 45 |
| address approaches 1 | |
| B5: B4 and threshold level of requests with | 50 |
| confidence score less than 25 | |

Bot detection system 340 assigns requests captured over a multi-day (i.e., long-term) time period to bucket 343. Bucket 343 represents a volumetric history of the request group. Assuming the request group (e.g., one of request groups 333) to be a fingerprint, the following steps describe the methodology used to compute bucket 343's score. Bot detection system 340 collects, on a per fingerprint level, three-day (or some other time period) time series metrics from datastore 332. Bot detection system 340 computes the bucket score for the fingerprint using an empirical formula that incorporates an auto-correlation function. In this example, bucket 343 relies solely on the analysis of time series data however bucket 343 may incorporate other analysis in other examples. For every fingerprint, this time series includes the number of requests received in a minute interval over the past three days. Bot detection system 340 analyzes this time series via two empirical tests and quantifies the continuous presence of the fingerprint in all the time bins and the presence or absence of a daily seasonal pattern for a fingerprint. The continuous presence is measured by calculating the gradient of a bin's start time with subsequent bin's start time and computing the variance of all the above gradients. Then, depending on the variance value, bot detection system 340 categorizes the fingerprints as being regular or continuously present, mildly irregular, or largely irregular on empirically determined variance thresholds. For example, bot detection system 340 may employ the following table to categorize fingerprints:

| | Variance Of Request |
|---|---|
| Behavior | Group's Time Bin Gradient |
| Regular and continuously present | 0 to 5,000 |
| Mildly Irregular | 5,000 to 100,000 |
| Largely Irregular | 100,000 and above |

Bot detection system 340 utilizes a heuristic to identify the presence or absence of a daily seasonal pattern in a fingerprint's time series based on the series' auto correlation function pattern. If a time series depicts periodicity, then its corresponding auto correlation function will be periodic. In addition, it can be inferred that a fingerprint's requests peak at a certain time of the day. Then the presence of such a peak, at daily interval, in a fingerprint's multi-day timeseries data allows bot detection system 340 to label the fingerprint's data to be seasonal. Mathematically, this can be identified based on a statistically significant correlation (r) of the time series' autocorrelation plot at a one day lag, a correlation value (r) at one day lag exceeds 0.5, and a dominant frequency of the timeseries is 1/1440 where 1440 is the number of one-minute time-bins in a day (assuming the timeseries is plotted with one minute time bins). When a fingerprint satisfies these conditions, bot detection system 340 labels the fingerprint as seasonal (i.e., periodic).

Bot detection system 340 combines the consistency metric and the seasonality metrics and assigns the fingerprint into one of the six patterns based on the consistency and seasonality level. These patterns include continuously present and strongly seasonal, continuously present and faintly seasonal, mildly irregular, largely irregular, rare, and seen once. Bot detection system generates long-term group scores 346 based on the observed pattern. For example, bot detection system 340 may use the following table to sort and generate a long-term group score a fingerprint:

| | Request Group's |
|---|---|
| | Long-Term |
| Time Series Pattern | Group Score |
| T1: Continuously present and strongly | 30 |
| seasonal | |
| T2: Continuously present and faintly seasonal | 20 |
| T3: Mildly Irregular | 15 |
| T4: Largely Irregular | 10 |
| T5: Rare (present in less than one percent of | 2 |
| time bins) | |
| T6: Seen once (present in only one time bin) | 1 |

After computing the individual request scores 344, short-term group scores 354, and long-term group scores 346 for buckets 341-343 respectively, bot detection system 340 generates an overall trust score for the request group. For example, the final trust score of a fingerprint may comprise algebraic sum of the fingerprint scores 344-346 for each of buckets 341-343 with 300 being the highest possible score and 0 being the lowest possible score. When the score for one of request groups 333 exceeds a threshold value (e.g., 80 out of 300), bot detection system 340 labels that request group as allowed. Bot detection system 340 provides a list of allowed request group (e.g., a request fingerprint whitelist) to security proxy 321. Security proxy 321 blocks requests that do not fall into at least one of the allowed request groups. Bot detection system 340 may display metrics characterizing the allowed request group list on dashboard 334.

Examples of user systems 301 and bots 302 include mobile computing devices, such as cell phones, tablet computers, laptop computers, notebook computers, and gaming devices, as well as any other type of mobile computing devices and any combination or variation thereof. Examples of user systems 301 and bots 302 also include desktop computers, server computers, and virtual machines, as well as any other type of computing system, variation, or combination thereof. User systems 301 may be representative of human controlled systems (e.g., a smartphone) while bots 302 are representative of automated systems. The computing system of user systems 301 and bots 302 may reside in a single device or may be distributed across multiple devices and may be a discrete system or could be integrated within other systems, including other systems within system 300.

Gateway 310 is a computing system that comprises a processing system and communication transceiver. Gateway 310 routes the requests for resources 323 to ones of APIs 322 in infrastructure 320. Gateway 310 may include components like a user interface, data storage system, and power supply. Examples of gateway 310 include Content Deliver Network (CDN) gateways, API gateways, default gateways, media gateways, payment gateways, Voice Over Internet Protocol (VOIP) gateways, residential gateways, enterprise gateways, cloud gateways, IoT gateways, as well as any other type of gateway computing devices and any combination or variation thereof. Examples of gateway 310 also include desktop computers, server computers, and virtual machines, as well as any other type of computing system, variation, or combination thereof. The computing system of gateway 310 may reside in a single device or may be distributed across multiple devices and may be a discrete system or could be integrated within other systems, including other systems within system 300.

API infrastructure 320 is representative of a web computing environment that comprises a processing system and communication transceiver. API infrastructure 320 may also include other components like a user interface, data storage system, and power supply. Examples of API infrastructure 320 may include server computers and data storage devices deployed on-premises, in the cloud, in a hybrid cloud, or elsewhere, by service providers such as enterprises, organizations, individuals, and the like. API infrastructure 320 may rely on the physical connections provided by one or more other network providers such as transit network providers, Internet backbone providers, and the like to communicate with and provide services 114 to external systems. In some examples, the computing systems of API infrastructure 320 could comprise a web server, CDN, forward/reverse proxy, load balancer, middleware, cloud server, network switch, router, switching system, packet gateway, network gateway system, Internet access node, application server, database system, service node, firewall, or some other communication system, including combinations thereof. The computing system of API infrastructure 320 may reside in a single device or may be distributed across multiple devices and may be a discrete system or could be integrated within other systems, including other systems within system 300.

APIs 322 are representative of a set of API servers, computing systems, and/or network equipment configured to provide services and web resources to clients and/or operators of infrastructure 320. In particular, APIs 322 provide web resources 323 in response to API calls from user systems 301 and potentially bots 302 if not blocked by security proxy 321. APIs 322 may comprise client-side APIs and server-side APIs. APIs 322 may be representative of any computing apparatus, system, or systems that may connect to another computing system over a communication network. APIs 322 comprise a processing system and communication transceiver. APIs 322 may also include other components such as routers, data storage systems, and power supplies. APIs 322 may reside in a single device or may be distributed across multiple devices. APIs 322 may comprise discrete systems or may be integrated within other systems, including other systems within system 300. Some examples of computing systems that host APIs 322 include database systems, server computers, cloud computing platforms, and virtual machines, as well as any other type of computing system, variation, or combination thereof. The API servers can be in various environments like the cloud, Kubernetes, serverless, data center, and the like.

Security proxy 321 is representative of servers, computing systems, and/or network equipment to enforce security policies on requests received and transferred by API infrastructure 320. The security policies block malicious or otherwise unwanted requests from reaching APIs 322. Proxy 321 generates and transfers data that characterizes the requests/responses to security platform 330. Proxy 321 comprises a processing system and communication transceiver. Proxy 321 may also include other components such as routers, data storage systems, and power supplies. Proxy 321 may reside in a single device or may be distributed across multiple devices. Proxy 321 may comprise discrete systems or may be integrated within other systems, including other systems within system 300. Some examples of computing systems that host proxy 321 include database systems, server computers, cloud computing platforms, and virtual machines, as well as any other type of computing system, variation, or combination thereof.

Security platform 330 is representative of a web security platform that processes the requests to determine human and bot behavior and generate security policies to block bot requests to APIs 322. Computing system 331, data store 332, dashboard 334, and bot detection system 340 in platform 330 may comprise servers, cloud computing systems, or any other computing system, network equipment, apparatus, system, or systems that may connect to another computing system over a communication network. Computing system 331, data store 332, dashboard 334, and bot detection system 340 comprise processing systems and communication transceivers. Computing system 331, data store 332, dashboard 334, and bot detection system 340 may also include other components such as a router, server, data storage system, and power supply. Computing system 331, data store 332, dashboard 334, and bot detection system 340 may reside in a single device or may be distributed across multiple devices. Computing system 331, data store 332, dashboard 334, and bot detection system 340 may be a discrete system or may be integrated within other systems, including other systems within system 300. Computing system 331, data store 332, dashboard 334, and bot detection system 340 include database systems, desktop computers, server computers, cloud computing platforms, and virtual machines, as well as any other type of computing system, variation, or combination thereof.

In some examples, bot security platform 330 may include a machine learning model and/or artificial intelligence system trained characterize human and bot behavior as described above. For example, computing system 331 may include a machine learning model (e.g., a classifier) trained to generate request groups 333, bucketize the requests into buckets 341-343, generates scores 344-346, determine an overall trust score, determine the allowed fingerprint list, and/or perform some other operation to classify human/bot behavior to block bot traffic. A machine learning model comprises one or more machine learning algorithms that are trained to produce outputs based on historical data and/or other types of training data. A machine learning model may employ one or more machine learning algorithms through which data can be analyzed to identify patterns, make decisions, make predictions, or similarly produce output. The machine learning model and/or artificial intelligence system may comprise random forest classifiers, Three Dimensional (3D) deep leaning models, 3D convolutional neural networks, Large Language Models (LLMs), times series convolutional deep learning, transformers, multi-layer perceptron, long term short memory, attention based deep learning model, artificial neural networks, nearest neighbor methods, ensemble random forests, support vector machines, naïve Bayes methods, linear regressions, or similar machine learning techniques or combinations thereof capable of predicting output based on input data.

In some examples, system 300 implements process 200 illustrated in FIG. 2 and/or process 400 illustrated in FIG. 4. It should be appreciated that the structure and operation of system 300 may differ in other examples.

FIG. 4 illustrates an example of process 400. Process 400 is representative of an exemplary operation of system 300 to characterize human and bot behavior. Portions of system 300 are referred to in the singular in process 400 for sake of clarity. In some examples, security proxy 311 copies requests received from users 301 and bots 302 to data store 322. Data store 332 sorts the requests into request groups 333 based on browser characteristics shared by the requests (i.e., one of request groups 333 includes a set of requests with shared browser characteristics). Request groups 333 may represent fingerprints, IP addresses, user agent strings, user agent header values, URLs, HTTP requests, and the like. Bot detection system (BDS) 340 selects one of request groups 333 and retrieves the requests assigned to that group as a batch.

Bot detection system 340 assigns the requests to buckets 341-343 to determine individual request characteristics, short-term group (i.e., fingerprint) characteristics, and long-term group characteristics. Bot detection system 340 determines the header position, header value, header value component count, and request version of the requests assigned to single request bucket 341 to determine individual request characteristics. Bot detection system 340 compares the header position, header value, header value component count, and request version of the requests to an expected header position, header value, header value component count, and request version for requests assigned to that bucket. Bot detection system 340 scores the requests to generate individual request score 344 based on the comparisons.

Bot detection system 340 determines the proportion of client transaction errors, the proportion of failed transactions, the proportion of the requests originating from untrusted ISPs, the average requests per client Internet Protocol IP address, and the proportion of the requests below a confidence threshold of requests assigned to single-day batch request bucket 342 to determine short-term group characteristics. Bot detection system 340 compares these attributes to respective thresholds (i.e., compare the proportion of client transaction errors to a client transaction error threshold) and generates short-term group score 354 based on which thresholds are triggered. For example, bot detection system 340 may generate a score of 14 when the proportion of client transaction errors does not exceed a threshold, but all of the other determined attributes exceed their respective thresholds.

Bot detection system 340 determines the volume of requests and the periodicity of the request volume of request assigned to multi-day batch request bucket 343 to determine long-term group characteristics. Bot detection system 340 compares the volume to an expected volume and/or the periodicity to an expected periodicity. Bot detection system 340 generates long-term group score 346 based on the comparisons. For example, bot detection system 340 may generate a score of 30 if the request volume periodicity is continuously present and strongly seasonal.

Bot detection system 340 derives an overall trust score for the selected one of request groups 333 based on individual request score 344, short-term group score 345, and long-term group score 346. For example, bot detection system 340 may utilize a weighted sum of scores 344-346 to determine the overall trust score. Bot detection system 340 applies a threshold to the overall trust score and marks the selected one of request groups 333 as trusted if its trust score triggers the threshold. Bot detection system 340 repeats the above process for the other ones of request groups 333. Bot detection system 340 generates a fingerprint list (i.e., a list of trusted request groups) and provides the fingerprint list to security proxy 311. Security proxy 311 blocks requests that do not fall into a trusted fingerprint. For example, security proxy 311 may determine requests received from bots 302 do not correspond to a trusted fingerprint and responsively block these requests to inhibit bots 302 from contacting APIs 322.

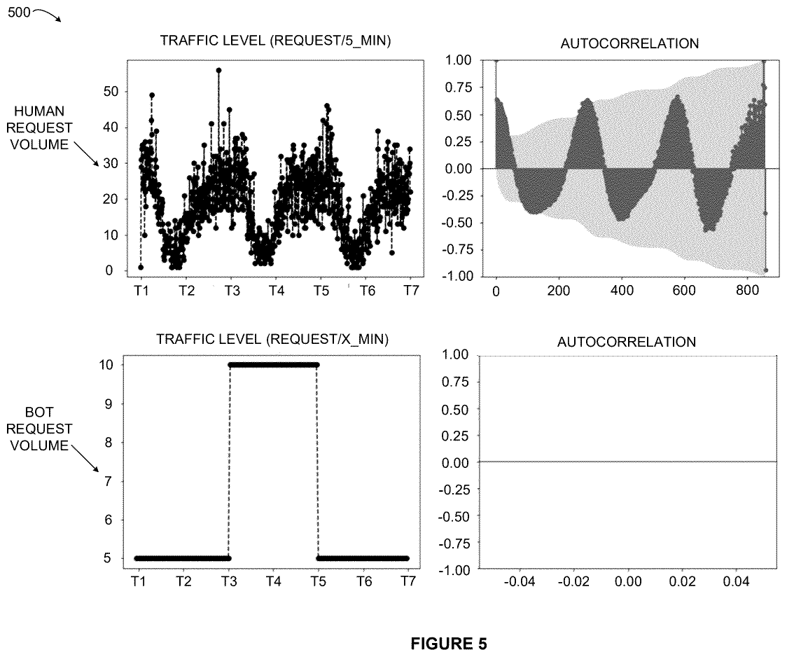

FIG. 5 illustrates charts 500 that characterize human or otherwise normal request volume and bot request volume. Charts 500 depict human request volume over time (top left), the resulting autocorrelation of the human request volume (top right), bot request volume over time (bottom left), and the resulting autocorrelation of the bot request volume (bottom left). The x-axes of the traffic level charts depict times in the range T1-T7, and the y-axes of the traffic level charts depict request volume in units of requests/time. The ranges depicted in charts 500 may differ in other examples. A security platform (e.g., bot detection system 340) may measure request volume and behavior depicted in charts 500 for different request fingerprints to identity acceptable (e.g., human) fingerprints and unwanted (e.g., bot) fingerprints. As illustrated in FIG. 5, human request volume towards an API infrastructure, web resource, or another type of communication endpoint exhibit are constantly present and periodic or otherwise seasonal. When an autocorrelation function is applied, the resulting periodicity and seasonality are present. For example, bot detection system 340 may utilize an autocorrelation function and observe the resulting periodicity and seasonality to identify request groups/fingerprints that comprise legitimate traffic. In contrast, the bot request volume exhibits a stepwise behavior with periods of inactivity and other periods of uniform activity. The period of uniform activity typically corresponds to a bot attack. When an autocorrelation function is applied to the bot traffic, the periodicity and seasonality are not present. For example, bot detection system 340 may utilize an autocorrelation function and observe the resulting lack of periodicity to identify request groups/fingerprints that comprise illegitimate traffic.

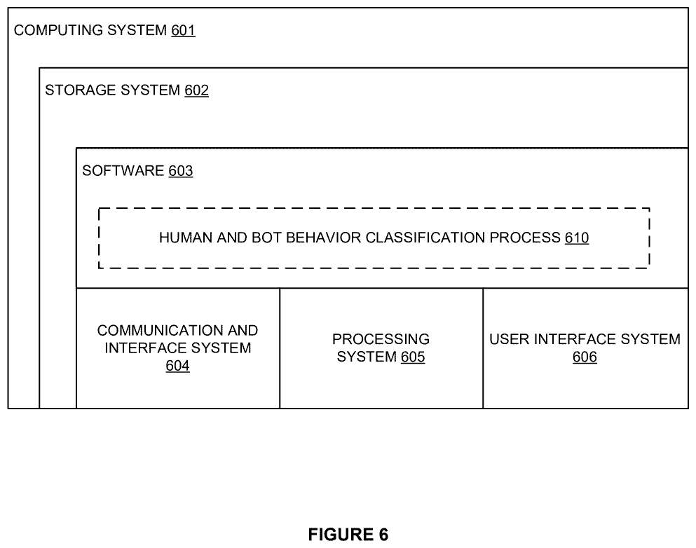

FIG. 6 illustrates computing device 601 which is representative of any system or collection of systems in which the various processes, programs, services, and scenarios disclosed herein to characterize human and bot behavior to block bot attacks. For example, computing device 601 may be representative of security proxy 110, processing circuitry 120, gateway 310, API infrastructure 320, security platform 330, and/or any other computing device contemplated herein. Examples of computing system 601 include, but are not limited to, server computers, routers, web servers, cloud computing platforms, and data center equipment, as well as any other type of physical or virtual server machine, physical or virtual router, container, and any variation or combination thereof.

Computing system 601 may be implemented as a single apparatus, system, or device or may be implemented in a distributed manner as multiple apparatuses, systems, or devices. Computing system 601 includes, but is not limited to, storage system 602, software 603, communication and interface system 604, processing system 605, and user interface system 606. Processing system 605 is operatively coupled with storage system 602, communication interface system 604, and user interface system 606.

Processing system 605 loads and executes software 603 from storage system 602. Software 603 includes and implements human and bot behavior classification process 610, which is representative of the processes to process requests sent towards an API infrastructure, classify the requests to characterize human/bot behavior, and block bot requests based on the characterization as described in the preceding Figures. For example, process 610 may be representative of process 200 illustrated in FIG. 2 and/or process 400 illustrated in FIG. 4. When executed by processing system 605, software 603 directs processing system 605 to operate as described herein for at least the various processes, operational scenarios, and sequences discussed in the foregoing implementations. Computing system 601 may optionally include additional devices, features, or functionality not discussed here for purposes of brevity.

Processing system 605 may comprise a micro-processor and other circuitry that retrieves and executes software 603 from storage system 602. Processing system 605 may be implemented within a single processing device but may also be distributed across multiple processing devices or sub-systems that cooperate in executing program instructions. Examples of processing system 605 include general purpose central processing units, graphical processing units, application specific processors, and logic devices, as well as any other type of processing device, combinations, or variations thereof.

Storage system 602 may comprise any computer readable storage media that is readable by processing system 605 and capable of storing software 603. Storage system 602 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 602 may also include computer readable communication media over which at least some of software 603 may be communicated internally or externally. Storage system 602 may be implemented as a single storage device but may also be implemented across multiple storage devices or sub-systems co-located or distributed relative to each other. Storage system 602 may comprise additional elements, such as a controller capable of communicating with processing system 605 or possibly other systems.

Software 603 (human and bot behavior classification process 610) may be implemented in program instructions and among other functions may, when executed by processing system 605, direct processing system 605 to operate as described with respect to the various operational scenarios, sequences, and processes illustrated herein. For example, software 603 may include program instructions for extracting features from HTTP requests associated with a fingerprint, bucketing the HTTP requests into a single request bucket, single day batch bucket, and multi-day batch bucket, and scoring the bucketed requests to determine the likelihood the HTTP requests associated with the fingerprint originated from a bot.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 603 may include additional processes, programs, or components, such as operating system software, virtualization software, or other application software. Software 603 may also comprise firmware or some other form of machine-readable processing instructions executable by processing system 605.

In general, software 603 may, when loaded into processing system 605 and executed, transform a suitable apparatus, system, or device (of which computing system 601 is representative) overall from a general-purpose computing system into a special-purpose computing system customized to characterize human and bot behavior to block bot attacks as described herein. Indeed, encoding software 603 on storage system 602 may transform the physical structure of storage system 602. The specific transformation of the physical structure may depend on various factors in different implementations of this description. Examples of such factors may include, but are not limited to, the technology used to implement the storage media of storage system 602 and whether the computer-storage media are characterized as primary or secondary storage, as well as other factors.

For example, if the computer readable storage media are implemented as semiconductor-based memory, software 603 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 604 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples provided herein are described in the context of computing devices to characterize human and bot behavior for bot attack mitigation, it should be understood that the systems and methods described herein are not limited to such embodiments and may apply to a variety of other extension implementation environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
obtaining requests and grouping the requests based on a characteristic shared by the requests to form a request group;
for each of the requests in the request group, determining a header characteristic and a body characteristic, comparing the header characteristic to an expected header characteristic, comparing the body characteristic to an expected body characteristic, and generating an individual request score based on the comparisons;
determining a short-term group characteristic for the request group and generating a short-term group score based on the short-term group characteristic;
determining a long-term group characteristic for the request group, comparing the long-term group characteristic to an expected long-term group characteristic, and generating a long-term group score based on the comparison; and
determining a trust score for the request group based on the individual request scores for each of the requests, the short-term group score, and the long-term group score, comparing the trust score to a threshold, and labeling the request group as trusted when the trust score exceeds the threshold.

2. The method of claim 1 wherein the request group comprises one or more of a fingerprint, Internet Protocol (IP) address, user agent string, user agent header value, Uniform Resource Locator (URL), and Hypertext Transport Protocol (HTTP) request.

3. The method of claim 1 wherein determining the header characteristic and the body characteristic, comparing the header characteristic to the expected header characteristic, and comparing the body characteristic to the expected body characteristic comprises determining a header position, header value, header value component count, and request version for each of the requests and comparing the header position, header value, header value component count, and request version to an expected header position, expected header value, expected header value component count, and expected request version.

4. The method of claim 1 wherein determining the short-term group characteristic and generating the short-term group score comprises determining a proportion of client transaction errors, a proportion of failed transactions, a proportion of the requests originating from untrusted Internet Service Providers (ISPs), average requests per client Internet Protocol (IP) address, and a proportion of the requests below a confidence threshold and generating the short-term group score based on the proportion of client transaction errors, proportion of failed transactions, proportion of the requests originating from untrusted ISPs, average requests per client IP address, and proportion of the requests below the confidence threshold.

5. The method of claim 1 wherein determining the long-term group characteristic and comparing the long-term group characteristic to the expected long-term group characteristic comprises determining a volume of the requests and comparing the volume of the requests to an expected volume of the requests.

6. The method of claim 5 wherein comparing the volume of the requests to the expected volume of the requests comprises determining when the volume of the requests comprises an expected periodicity.

7. The method of claim 1 further comprising generating security policies to block additional requests that do not conform to the trusted request group.

8. A system comprising:
processing circuitry configured to:
obtain requests and group the requests based on a characteristic shared by the requests to form a request group;
for each of the requests in the request group, determine a header characteristic and a body characteristic, compare the header characteristic to an expected header characteristic, compare the body characteristic to an expected body characteristic, and generate an individual request score based on the comparisons;
determine a short-term group characteristic for the request group and generate a short-term group score based on the short-term group characteristic;
determine a long-term group characteristic for the request group, compare the long-term group characteristic to an expected long-term group characteristic, and generate a long-term group score based on the comparison; and
determine a trust score for the request group based on the individual request scores for each of the requests, the short-term group score, and the long-term group score, compare the trust score to a threshold, and label the request group as trusted when the trust score exceeds the threshold.

9. The system of claim 8 wherein the request group comprises one or more of a fingerprint, Internet Protocol (IP) address, user agent string, user agent header value, Uniform Resource Locator (URL), and Hypertext Transport Protocol (HTTP) request.

10. The system of claim 8 wherein the processing circuitry is further configured to determine a header position, header value, header value component count, and request version for each of the requests, compare the header position, header value, header value component count, and request version to an expected header position, expected header value, expected header value component count, and expected request version, and generate the generate the individual request score based on the comparisons.

11. The system of claim 8 wherein the processing circuitry is further configured to determine a proportion of client transaction errors, a proportion of failed transactions, a proportion of the requests originating from untrusted Internet Service Providers (ISPs), average requests per client Internet Protocol (IP) address, and a proportion of the requests below a confidence threshold and generate the short-term group score based on the proportion of client transaction errors, proportion of failed transactions, proportion of the requests originating from untrusted ISPs, average requests per client IP address, and proportion of the requests below the confidence threshold.

12. The system of claim 8 wherein the processing circuitry is further configured to determine a volume of the requests, compare the volume of the requests to an expected volume of the requests, and generate a long-term group score based on the comparison.

13. The system of claim 12 wherein the processing circuitry is further configured to determine when the volume of the requests comprises an expected periodicity.

14. The system of claim 8 wherein the processing circuitry is further configured to generate security policies to block additional requests that do not conform to the trusted request group.

15. One or more computer-readable storage media having program instructions stored thereon, wherein the program instructions, when executed by a computing system, direct the computing system to perform operations, the operations comprising:
obtaining requests and grouping the requests based on a characteristic shared by the requests to form a request group;
for each of the requests in the request group, determining a header characteristic and a body characteristic, comparing the header characteristic to an expected header characteristic, comparing the body characteristic to an expected body characteristic, and generating an individual request score based on the comparisons;
determining a short-term group characteristic for the request group and generating a short-term group score based on the short-term group characteristic;
determining a long-term group characteristic for the request group, comparing the long-term group characteristic to an expected long-term group characteristic, and generating a long-term group score based on the comparison; and
determining a trust score for the request group based on the individual request scores for each of the requests, the short-term group score, and the long-term group score, comparing the trust score to a threshold, and labeling the request group as trusted when the trust score exceeds the threshold.

16. The computer-readable storage media of claim 15 wherein the request group comprises one or more of a fingerprint, Internet Protocol (IP) address, user agent string, user agent header value, Uniform Resource Locator (URL), and Hypertext Transport Protocol (HTTP) request.

17. The computer-readable storage media of claim 15 wherein determining the header characteristic and the body characteristic, comparing the header characteristic to the expected header characteristic, and comparing the body characteristic to the expected body characteristic comprises determining a header position, header value, header value component count, and request version for each of the requests and comparing the header position, header value, header value component count, and request version to an expected header position, expected header value, expected header value component count, and expected request version.

18. The computer-readable storage media of claim 15 wherein determining the short-term group characteristic and generating the short-term group score comprises determining a proportion of client transaction errors, a proportion of failed transactions, a proportion of the requests originating from untrusted Internet Service Providers (ISPs), average requests per client Internet Protocol (IP) address, and a proportion of the requests below a confidence threshold and generating the short-term group score based on the proportion of client transaction errors, proportion of failed transactions, proportion of the requests originating from untrusted ISPs, average requests per client IP address, and proportion of the requests below the confidence threshold.

19. The computer-readable storage media of claim 15 wherein determining the long-term group characteristic and comparing the long-term group characteristic to the expected long-term group characteristic comprises determining a volume of the requests and comparing the volume of the requests to an expected volume of the requests.

20. The computer-readable storage media of claim 19 wherein comparing the volume of the requests to the expected volume of the requests comprises determining when the volume of the requests comprises an expected periodicity.
